(19) United States
(12) Patent Application Publication
(10) Pub. No.: US 2005/0099077 A1
(43) Pub. Date: May 12, 2005

(54) Magnetic coupling using magnets on a motor rotor

(76) Inventor: Sten R. Gerfast, Mendota Heights, MN (US)

Correspondence Address: STEN R. GERFAST, 1802 VALLEY CURVE ROAD, MENDOTA HEIGHTS, MN, 55118, US

(21) Appl. No.: 10/703,656

(22) Filed: Nov. 10, 2003

(51) Int. Cl. H02K 16/02; H02K 49/00; H02K 7/09

(52) U.S. Cl. 310/104; 310/103; 310/114

(57) ABSTRACT

A simplified magnetic coupling utilizing the available rotating permanent magnets on an electric motor rotor to be the “drive” component in the magnetic coupling of the present invention. The “driven part of the magnetic coupling is a co-axially journalled second rotor, driven by magnetic flux from the rotating permanent magnets on the motor rotor mentioned above. A membrane between these two rotors can hermetically separate the drive part from the driven part. This invention has fewer parts, has both less costly parts and assembly and is also more compact then related art.

### TECHNICAL FIELD

This invention relates to magnetic couplings or clutches, and relates to torque-transmission using magnetic flux, generally between disc's, or rotating components across an air gap.

The rotating, non-contacting, components could be separated by a membrane that is enclosing some of these components hermetically. The output component could be used for driving a mechanical device, or a pump for pumping a gas or liquids.

### DESCRIPTION OF RELATED ART

Most systems available today for transmission of torque by magnetic methods are consisting of three or more basic parts with their sub-assemblies: Motor, Input (drive) disc and Output (driven) disc. The motor or engine with it's output shaft is sometimes connected to the drive disc with a flexible coupling to allow for a small amount of misalignment between the shaft from the rotor to the magnetic disc drive assembly.

The drive assembly is generally supported on it's own bearings, separate from the motor bearings, and generally has multiple magnets assembled to it.

The driven part generally also has multiple magnets assembled to a disc, and since at times the rotational speed of the input and output disc's a different, the secondary driven disc assembly again has it's own shaft supported on bearings.

These two sets of multiple magnet assemblies, a multitude of bearings, couplings and shafts make the total assembly both complex and expensive. A generalized view of a related art type unit is shown in FIG. 2.

### THE PRESENT INVENTION

It is the object of the present invention to provide a less complex device with fewer components, meaning lower component costs, and components that also are less costly to assemble. Fewer components also mean that this new invention can be made more compact.

Yet all the different possible embodiments have greater efficiencies because of lower friction.

The present invention could be described as:

a rotating electric motor rotor, a non-touching cylinder co-axially journalled with said rotor, with a magnetic pattern on the inside and outside faces of both said rotor and said cylinder, said two magnetic patterns providing a magnetic coupling between said rotor and said cylinder.

The pattern could be north/south segment magnetization on one side of a specific cylinder and a south/north magnetization physically directly opposite on the other side of that specific cylinder. This magnetic pattern could be magnetized on a ferro magnetic cylinder but the preferred material is a ring shaped or segmented permanent magnet material.

This invention is using this somewhat un-obvious scientific fact that a magnet with a north pole on it's one side, has a magnetically neutral center and a has a south pole on it's other side.

This also conforms to the stated “law”: “There can not exist a magnetic mono pole”.

The magnetic coupling between these two parts; when north and south poles on an inside rotor face is lining up with south and north poles on the outside cylinder face can result in a substantial coupling force.

And an air gap between these two “cylinders” can be somewhat larger then an air gap between two disc's (with equal magnet segment strength) to produce the same coupling force. This is because the flux lines from a north pole to a south pole and return flux lines from south pole to north pole are shorter and more confined and concentrated in a cylinder layout than in a disc layout.

Some electric motors, such as brushless motors, have permanent magnet segments assembled to its rotor.

These magnets are co-acting with the motors stator-face to make the motor run and produce torque at the motors output shaft. The stator face is substantially a cylinder.

The magnet segments on the rotor are semi-cylindrical, with either an inside or an outside semi-cylinder segment facing the stator, depending on the construction of the motor.

Motor windings on the stator energize the stator to produce torque between it and the magnets. A large surface area of the semi-cylindrical face of the permanent magnets, that is on the opposite side that produces torque in the motor, also has magnetic flux that normally is not used, but is utilized in the present inventions magnetic coupling. In some motors even the end-face of the permanent magnets is available.

Using this available flux in a magnetic coupling does not substantially detract from the permanent magnets torque creation at the motor shaft.

These permanent magnet segments are already mounted in a cylinder form on a rotating assembly (the motors rotor and shaft) and therefore does not require any separate couplings or additional shafts and bearings.

This rotor assembly becomes the “drive” part of the magnetic coupling of the present invention.

The “driven” part of the magnetic coupling is again basically shaped like a cylinder that has a plurality of magnetic pole pattern, or segments, made from a magnetic material, generally with the same number of poles or segments as the motors has magnet segments. The attraction between these segments and the permanent magnet segments on the motor rotor is the transmitting torque, across an air gap, in this magnetic coupling assembly.

A membrane could be inserted in that air gap separating the drive from the driven parts. A further object of the invention could be to replace the magnet segments with a set of ferro-magnetic salient poles to decrease the cost of the driven cylinder, but with a decrease in coupling force. The driven cylinder assembly could have it's own shaft and bearings that would be co-axially journalled with the motor. If this driven cylinder is attached to an impeller for pumping a fluid the mentioned bearing could be fluid lubricated.

This type of “magnetic force” drive coupling also has a secondary advantage:
it can accept mis-alignment and be somewhat nonconcentric.

In a comparative test, using the same magnetic flux and the same spacing of the drive/driven assemblies, between the present invention and other existing magnetic couplings, the present invention would also be more efficient because of its lower frictional losses in its fewer parts.

The advantage of any magnetic coupling is that since there is no mechanical connection between the drive and the driven part, a membrane can be inserted between these two parts as mentioned above. This facilitates a hermetic enclosure around either part without any shaft seals with high friction. This advantage is of course also available, and is present on the present invention. The hermetic enclosure, or membrane, gives a definite advantage when used in a magnetic coupling for a pump that could be used for pumping a gas or liquid, especially when they are flammable.

A second description of this magnetic coupling device of the present invention could be:

A magnetic coupling comprising:

An electric motor rotor energized for rotation by a stator across a first air gap,
said rotor having a first set of a plurality of permanent magnets,
co-axially journalled with said first rotor, a second rotor having a second set of permanent magnets, wherein magnetic flux from said first set couples into said second set across a second air gap, producing torque on said second rotor.

### BRIEF DESCRIPTION OF THE DRAWINGS

FIG. 1 is a partial cross sectional view of a magnetic coupling using an electric motor's internal magnets as described in the present invention.

FIG. 2 is a general view of a magnetic coupling representative of the prior art.

### DETAILED DESCRIPTION

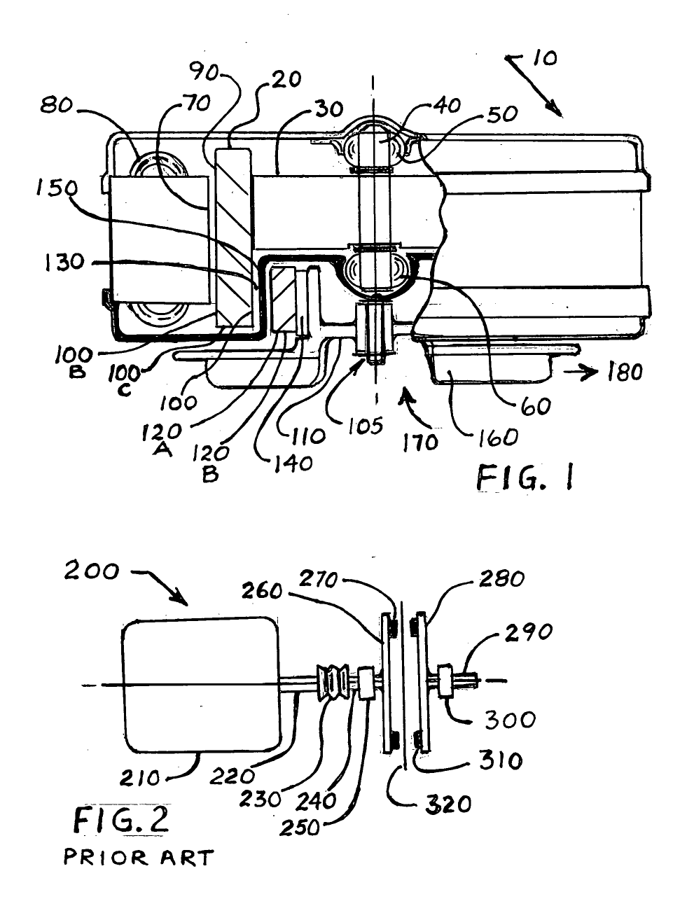

FIG. 1 illustrates one possible embodiment of the present invention 10 using an electric motor's permanent magnets 20 mounted in a cylindrical fashion on the motor rotor 30 having a shaft 40 that is journalled on bearings 50 and 60. The permanent magnets 20 could be a solid cylindrical ring, but is more often made up from semi-cylindrical magnet segments into a cylindrical ring, and will be described as segments 20.

These magnet segments 20 are co-acting with the motor's stator-face 70 to produce torque when the stator's windings 80 are energized. The stator-face 70 is substantially cylindrical. The magnet segments 20 has a semi-cylindrical face 90 facing the stator-face 70 and also has a semi-cylindrical inside face 100. This magnet face 100 and its magnetic flux is in this embodiment used for coupling to a second rotor.

In alternate embodiments of the present invention the magnet segment face 100 B which is an outside semi-cylindrical face, and 100 C which is an end face could be used for the same purpose.

The magnetic flux emanating from magnet face 100 is the “drive” part of this inventions magnetic coupling. A co-axially journalled (105) second rotor 110 is the “driven” part and is having a plurality of magnet segments 120 A bonded together to form a cylinder, preferably having the same number of segments 120 A as magnetic segments 20.

One manufacturing method of the second rotor would be to mold it from a plastic material with pockets to rive the magnetic segments 120 A. The magnet face 100 and second rotor 110 are non-contacting, with magnetic flux going from face 100 to second rotor's magnetic pole segments 120 A through an air gap 130. To further increase coupling force, or torque, a soft iron ring 140 could be placed back of the magnet segments 120 A. The magnet segments 120A could be replaced by ferro-magnetic salient poles for economy, but with decreased torque.

In the air gap 130 is preferably mounted a membrane 150 separating the drive from the driven part. This membrane 150 can be used to hermetically enclose the drive part from the driven part and also prevent gas or liquid from passing from second rotor to motor rotor.

Connected to second rotor 110 is shown an attached radial impeller 160 having a center inlet 170 and a peripheral outlet 180. This type of impeller could pump a gas or a liquid, but is only one of the many different embodiments were this invention could be very useful.

In addition to being both simple and easily manufactured, with fewer parts than competitive devices this new invention is also less costly and more compact.

FIG. 2 is showing a general view of a magnetic coupling 200 generally available on the market today.

A motor 210 has an output shaft 220 that is connected to a flexible coupling 230 that in turn is connected through a shaft 240 with bearings 250, to a disc 260 with a set of magnets 270. A second disc 280, also with a shaft 290 on bearings 300 has a second set of magnets 310 to become the driven part. A membrane 320 could be placed between disc 260 and disc 280.

The illustrations of the present invention that are shown are by no means conclusive. A person skilled in the art could easily make many different configurations, uses and alterations.

1. A magnetic coupling comprising:
a rotating electric motor rotor, a non-touching cylinder co-axially journalled with said rotor, with a magnetic pattern on the inside and outside faces of both said rotor and said cylinder, said two magnetic patterns providing a magnetic coupling between said rotor and said cylinder.

2. A magnetic coupling as defined in claim 1 wherein said pattern having
north/south segment magnetization on inside, and south/north magnetization on outside faces of said cylinder and said rotor.

3. A magnetic coupling as defined in claim 1 wherein said rotor is energized to rotate by a motor stator across an air gap and total air gaps are two.

4. A magnetic coupling as defined in claim 1 wherein said rotor has electro-magnetic-energization for rotation.

5. A magnetic coupling as defined in claim 3 wherein a membrane is placed in one of said air gaps.

6. A magnetic coupling comprising:
An electric motor rotor energized for rotation by a stator across a first air gap,
said rotor having a first set of a plurality of permanent magnets,
co-axially journalled with said first rotor, a second rotor having a second set of permanent magnets, wherein magnetic flux from said first set couples into said second set across a second air gap, producing torque on said second rotor.

7. A magnetic coupling as defined in claim 6 wherein
said magnets on said motor rotor is both torque producing and providing magnetic coupling force.

8. A magnetic coupling as defined in claim 6 wherein said second set of permanent magnets are replaced with a second set of ferro-magnetic salient poles.

9. A magnetic coupling as defined in claim 6 wherein said motor rotor and said second rotor are separated by a membrane enclosing said motor rotor hermetically.

10. A magnetic coupling as defined in claim 6 wherein said second rotor and its magnets are attached to a mechanical part such as an impeller.

11. A magnetic coupling as defined in claim 6 wherein said co-axial journal is fluid lubricated.

12. A magnetic coupling as defined in claim 6 wherein
said membrane prevents gas or liquid from passing from second rotor to motor rotor.

13. A magnetic coupling as defined in claim 6 wherein said membrane is made from a non-magnetic or non-conductive material with pockets for said magnets.

14. A magnetic coupling as defined in claim 6 wherein said magnetic coupling occurs at the outside cylindrical face of said second set of permanent magnet segments.

15. A magnetic coupling as defined in claim 6 wherein
said magnetic coupling occurs at the inside cylindrical face of said permanent magnet segments.

16. A magnetic coupling as defined in claim 6 wherein
said magnetic coupling occurs at the end face of said permanent magnet segments.

17. A magnetic coupling as defined in claim 1 wherein
said magnetic coupling provides both holding torque and running torque.

18. A magnetic coupling as defined in claim 6 wherein
said magnetic coupling across an air gap is non-contacting.

19. A magnetic coupling as defined in claim 1 wherein
co-axial mounting eliminates the need for a flexible coupling.
